(19) United States
(12) Patent Application Publication
(10) Pub. No.: US 2017/0087947 A1
(43) Pub. Date: Mar. 30, 2017

(54) Trailer Hitch with Hold-Down Retainer

(71) Applicant: Larry T. Moore, Kissimmee, FL (US)

(72) Inventor: Larry T. Moore, Kissimmee, FL (US)

(21) Appl. No.: 15/279,859

(22) Filed: Sep. 29, 2016

Related U.S. Application Data
(60) Provisional application No. 62/235,250, filed on Sep. 30, 2015.

(51) Int. Cl. B60D 1/58; B60D 1/28; B60D 1/06

(52) U.S. Cl. CPC B60D 1/583; B60D 1/065; B60D 1/28

(57) ABSTRACT

A trailer hitch with hold-down retainer is a device used to prevent a trailer from separating from a vehicle to which the trailer is attached. The device includes an elongated mounting arm that is inserted into a trailer hitch receiver. The device includes a ball platform that is joined to the elongated mounting arm by a connector arm. A hitch ball is mounted to the ball platform and serves as a mounting point for a trailer coupler to be attached to the present invention. A retainer assembly featuring a hold-down is utilized to physically prevent the trailer coupler from separating from the hitch ball. The hold-down is offset from the hitch ball by a specified distance, enabling the hold-down to secure the trailer coupler in place.

The current application claims a priority to the U.S. Provisional Patent application Ser. No. 62/235,250 filed on Sep. 30, 2015.

### FIELD OF THE INVENTION

The present invention relates generally to a trailer hitch. More specifically, the present invention is a trailer hitch with hold-down retainer that prevents a trailer from separating from a vehicle to which the trailer is attached.

### BACKGROUND OF THE INVENTION

Trailer hitches are typically utilized when securing a trailer or vehicle for transportation. A trailer hitch may be attached to the chassis of a vehicle in order to provide a mounting point for a trailer or vehicle. A common type of trailer hitch is a ball-type hitch that may be secured to a trailer coupler. The ball-type hitch enables an attached trailer or vehicle to swivel, pivot, and otherwise move during transit. It is important that a trailer hitch remains level for safety and security. One of the most common safety issues related to trailer hitches is the possibility of a trailer uncoupling and separating from a trailer hitch. Because of the inherent danger of separation of the trailer from the trailer hitch, a means of securing the trailer in place on the trailer hitch is often desirable.

The present invention is a trailer hitch with hold-down retainer that is utilized to prevent a trailer from separating from a trailer hitch. The present invention prevents a trailer coupler that is mounted to a vehicle trailer hitch from separating from the trailer hitch. The present invention may be utilized with a wide variety of vehicles.

### BRIEF DESCRIPTION OF THE DRAWINGS

FIG. 1 is a perspective view of the present invention.

FIG. 2 is a front view of the present invention.

FIG. 3 is a cross-sectional view of the present invention taken along line A-A of FIG. 2.

FIG. 4 is an exploded perspective view of the present invention.

FIG. 5 is a perspective view of a first alternative embodiment of the present invention.

FIG. 6 is an exploded perspective view of the first alternative embodiment of the present invention.

FIG. 7 is a perspective view of a second alternative embodiment of the present invention.

FIG. 8 is a front view of the second alternative embodiment of the present invention.

FIG. 9 is a cross-sectional view of the present invention taken along line B-B of FIG. 8.

FIG. 10 is an exploded perspective view of the second alternative embodiment of the present invention.

FIG. 11 is a perspective view of a third alternative embodiment of the present invention.

FIG. 12 is a front view of the third alternative embodiment of the present invention.

FIG. 13 is a cross-sectional view of the present invention taken along line C-C of FIG. 12.

FIG. 14 is an exploded perspective view of the third alternative embodiment of the present invention.

### DETAIL DESCRIPTIONS OF THE INVENTION

All illustrations of the drawings are for the purpose of describing selected versions of the present invention and are not intended to limit the scope of the present invention.

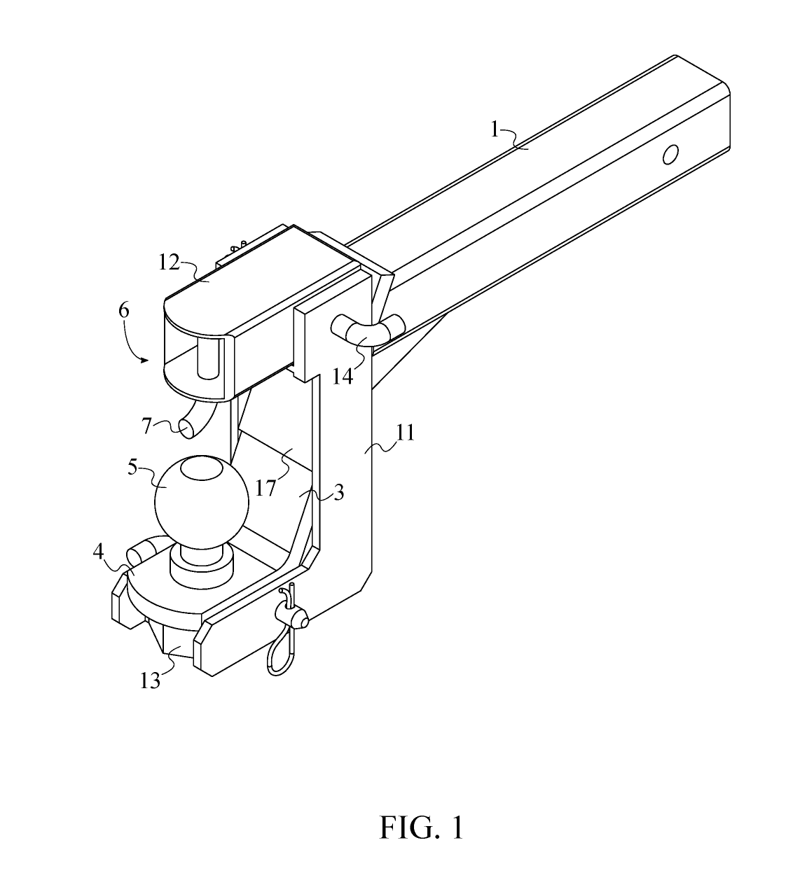

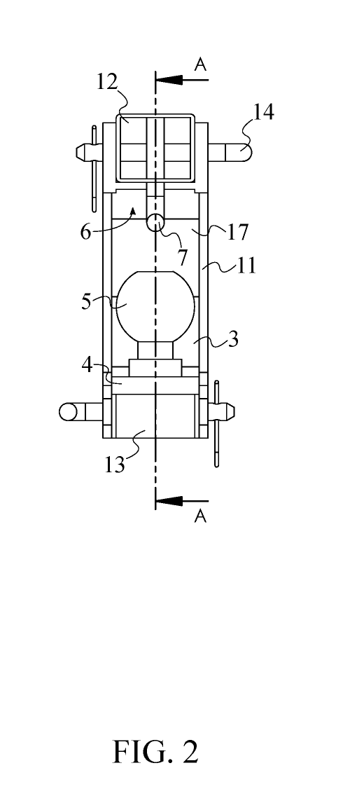

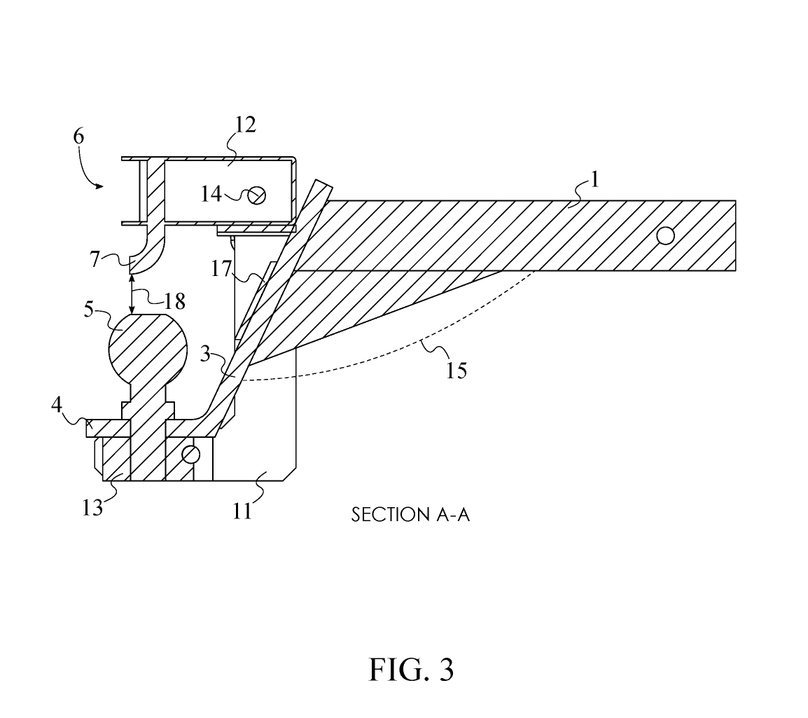

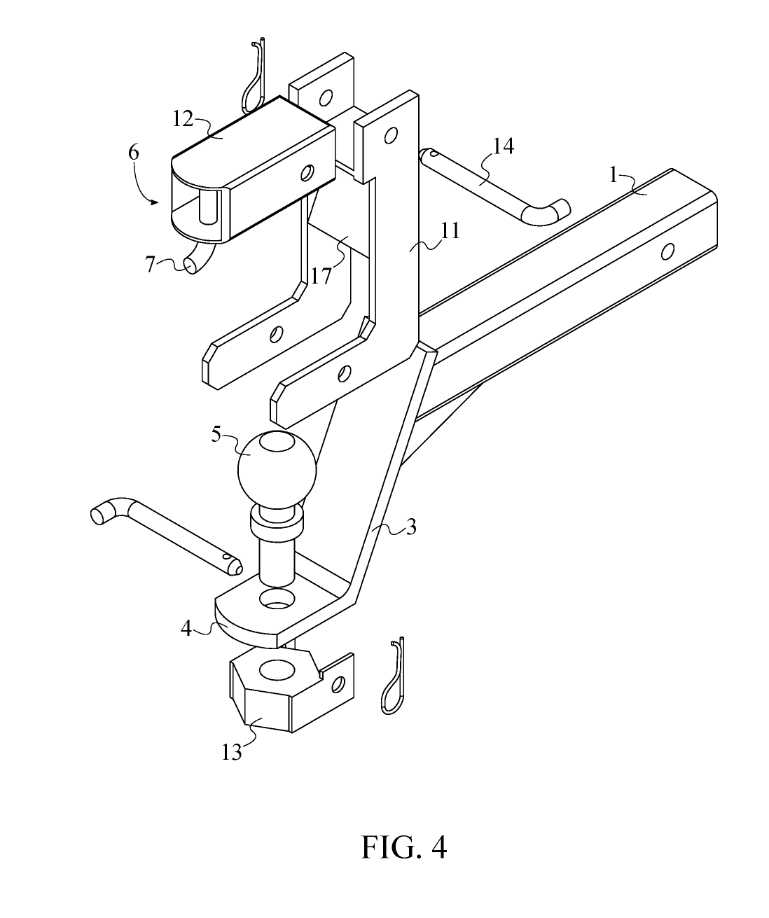

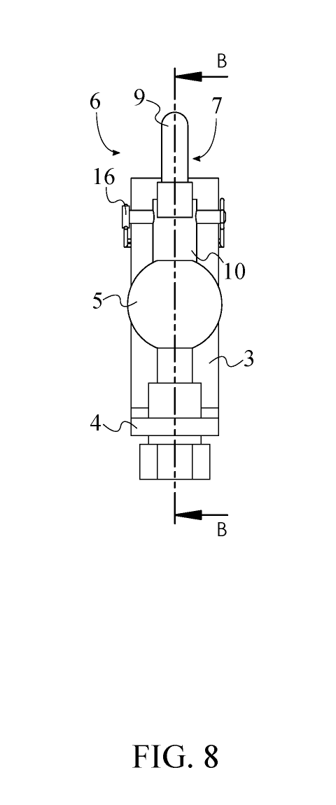

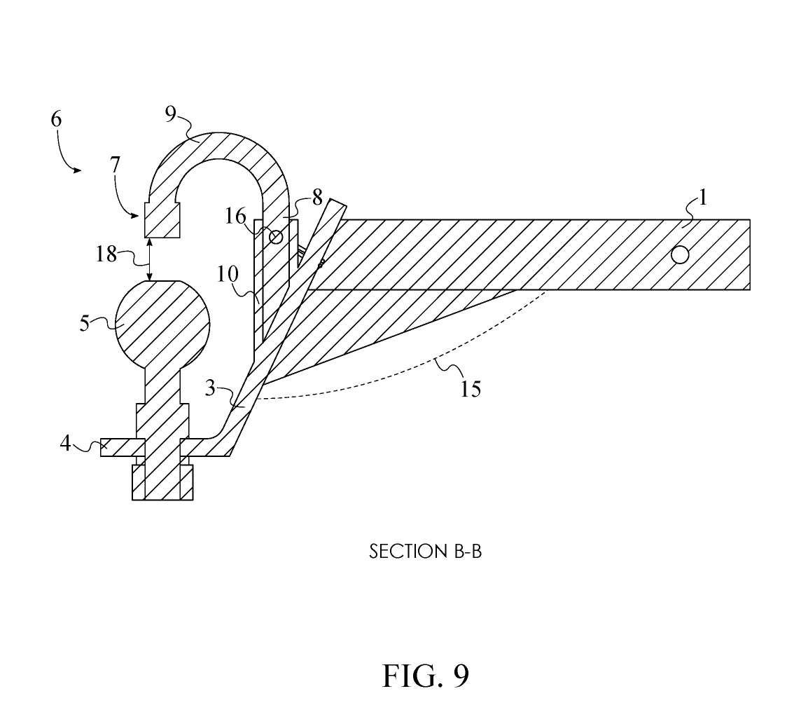

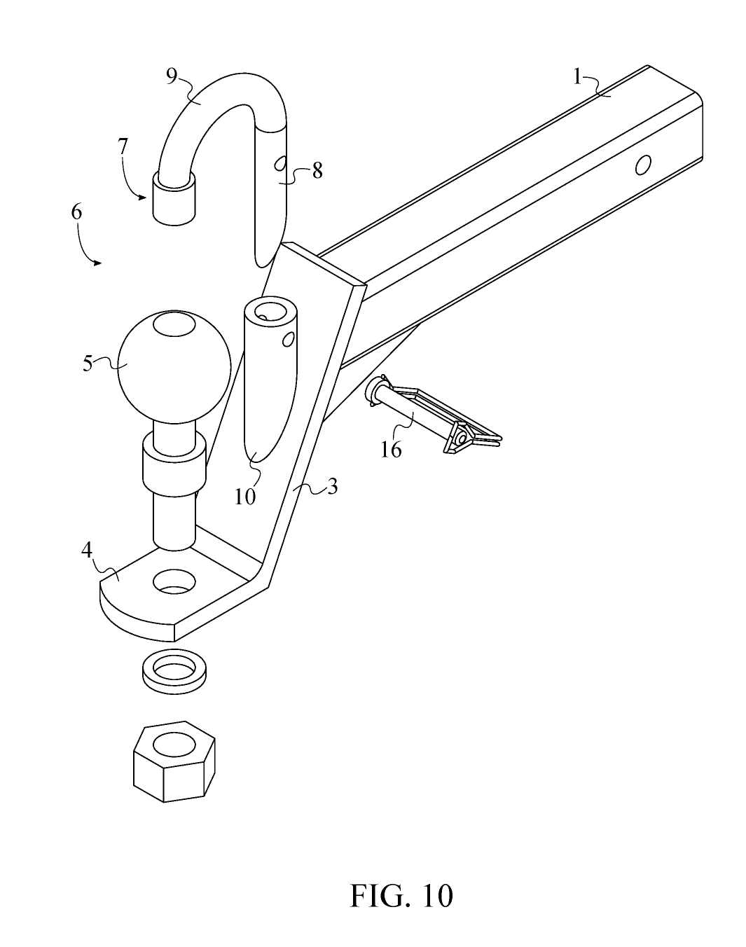

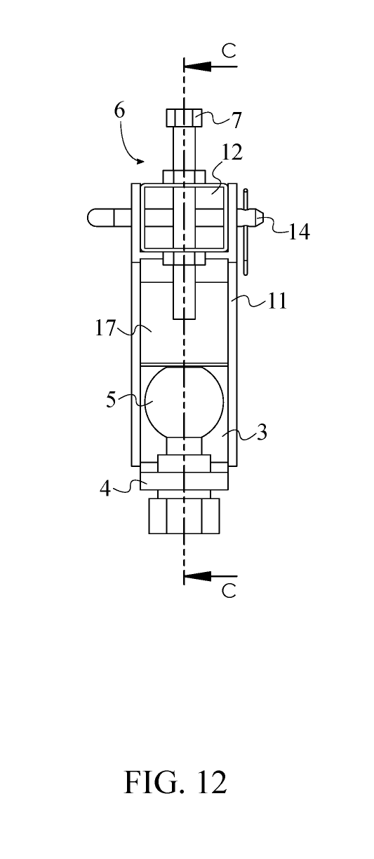

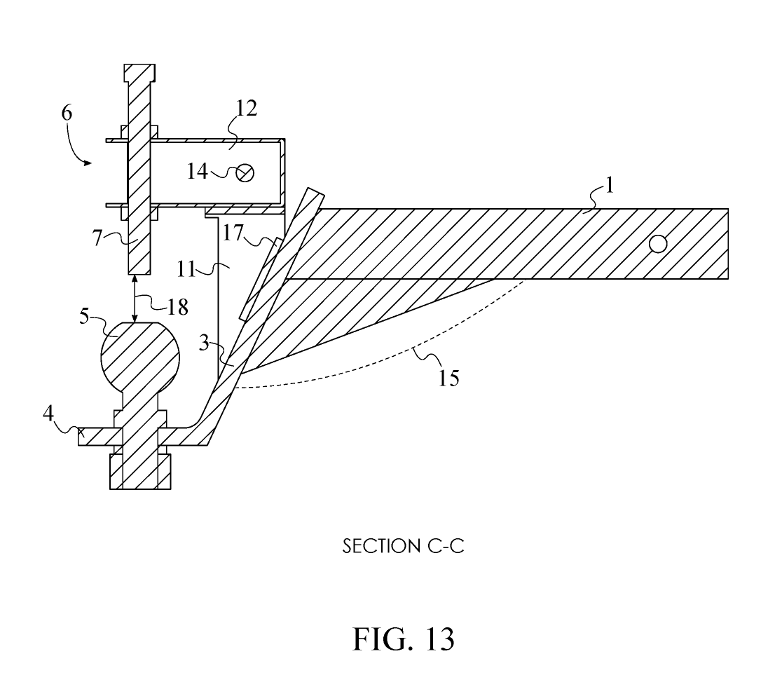

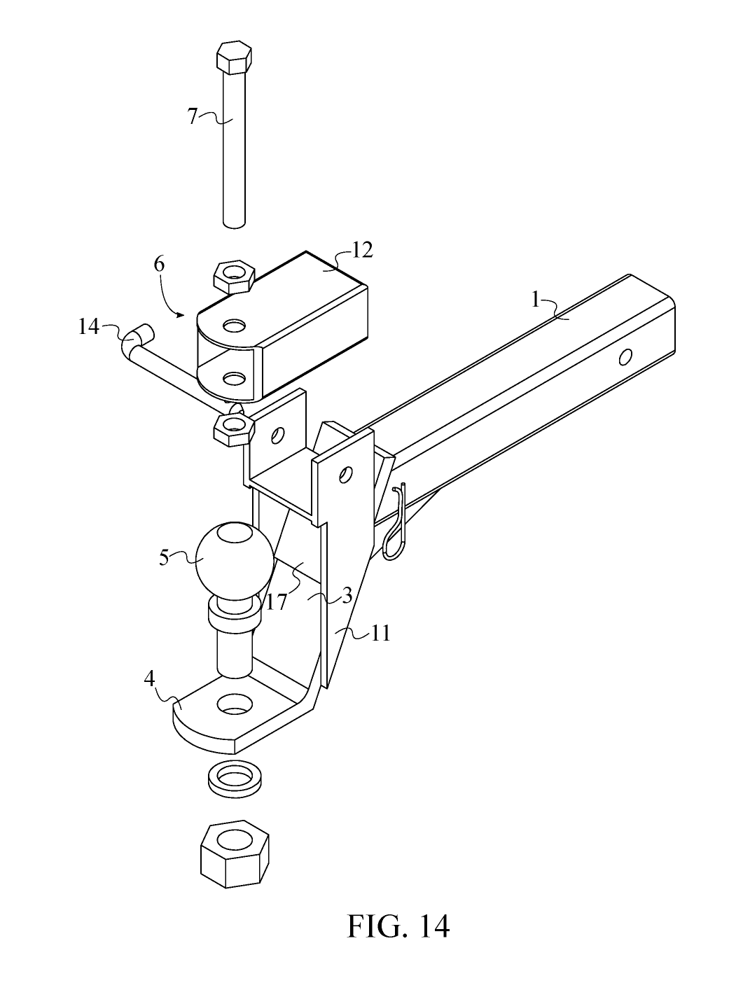

The present invention is a trailer hitch with hold-down retainer. The present invention prevents the separation of a trailer from a trailer hitch that is mounted to a vehicle. Multiple embodiments of the present invention are shown in FIGS. 1-14. The present invention comprises an elongated mounting arm 1, a connector arm 3, a ball platform 4, a hitch ball 5, and a retainer assembly 6.

The elongated mounting arm 1 is an elongated member that may be engaged into a trailer hitch receiver. The connector arm 3 joins the elongated mounting arm 1 to the ball platform 4. The connector arm 3 is terminally connected to the elongated mounting arm 1 and is positioned away from the end of the elongated mounting arm 1 that is inserted into a trailer hitch receiver. The ball platform 4 serves as a mounting point for the hitch ball 5. The ball platform 4 is terminally connected to the connector arm 3, opposite to the elongated mounting arm 1. As such, the ball platform 4 is positioned away from the vehicle to which the present invention is secured. The ball platform 4 is oriented parallel to the elongated mounting arm 1, ensuring that a mounted trailer remains level with the ground when the elongated mounting arm 1 is inserted into a trailer hitch receiver. The hitch ball 5 serves as a mounting point onto which a trailer coupler may be secured. The hitch ball 5 is mounted to the ball platform 4, providing a mounting point that is positioned away from the elongated mounting arm 1 and the vehicle to which the present invention is secured.

The retainer assembly 6 is utilized to prevent a trailer coupler from separating from the hitch ball 5 after a trailer has been secured to the present invention. The retainer assembly 6 is mounted in between the elongated mounting arm 1 and the hitch ball 5. The retainer assembly 6 thus does not interfere with the ability to insert the elongated mounting arm 1 into a trailer hitch receiver. The retainer assembly 6 comprises a hold-down 7 that is used to physically prevent a trailer coupler from separating from the hitch ball 5. The hold-down 7 is offset from the hitch ball 5 by a specified distance 18, providing sufficient space for the trailer coupler to be secured to the hitch ball 5. The hold-down 7 may be adjusted in order to secure the trailer coupler in place on the hitch ball 5 and prevent separation.

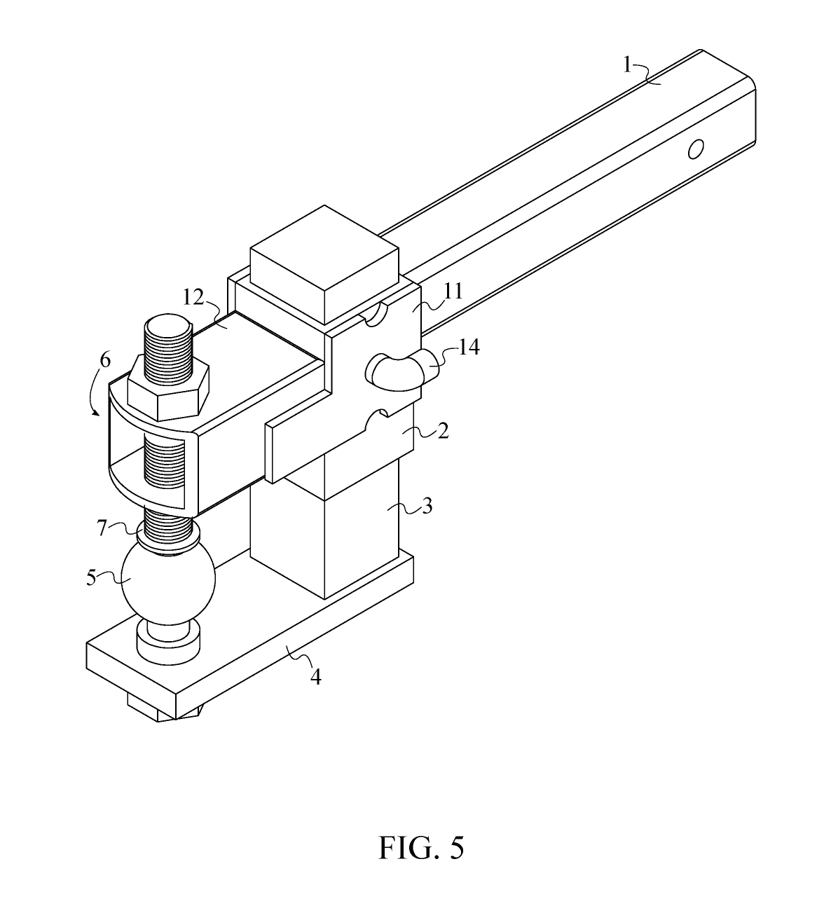

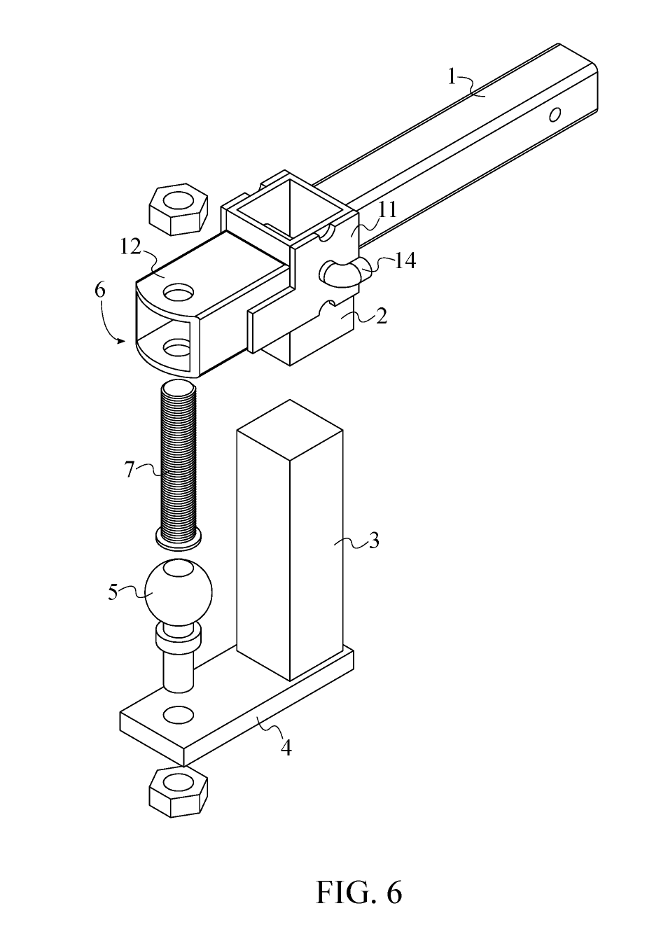

In the embodiment of the present invention shown in FIG. 5 and FIG. 6, the connector arm 3 is removably connected to the elongated mounting arm 1. The position of the connector arm 3 relative to the elongated mounting arm 1 may thus be adjusted. The present invention further comprises a clevis pin 14 that is utilized to secure the connector arm 3 within the perpendicular sleeve 2. The elongated mounting arm 1 comprises a perpendicular sleeve 2 that accommodates the connector arm 3. The connector arm 3 is mounted into the perpendicular sleeve 2, enabling the connector arm 3 to slide within the perpendicular sleeve 2. The clevis pin 14 laterally traverses through the perpendicular sleeve 2 and the connector arm 3. The clevis pin 14 is thus able to hold the connector arm 3 in place within the perpendicular sleeve 2.

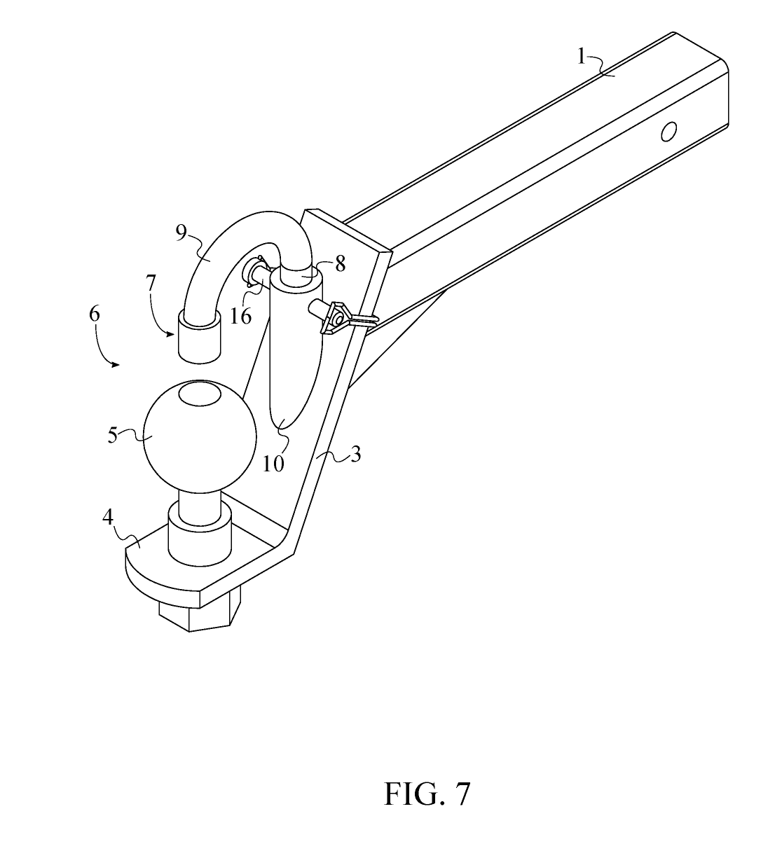

In the embodiment of the present invention shown in FIGS. 7-10, the hold-down 7 comprises a linear portion 8 and a curved portion 9. The retainer assembly 6 further comprises a sheath 10 that is utilized to accommodate the hold-down 7. The connector arm 3 is oriented at an obtuse angle 15 to the elongated mounting arm 1, positioning the ball platform 4 and the hitch ball 5 away from the elongated mounting arm 1. The sheath 10 is positioned on the connector arm 3, positioning the hold-down 7 in between the elongated mounting arm 1 and the hitch ball 5. Additionally, the sheath 10 is oriented perpendicular to the elongated mounting arm 1, enabling the hold-down 7 to be positioned and oriented to prevent a trailer coupler from separating from the hitch ball 5. The linear portion 8 is removably engaged into the sheath 10, while the curved portion 9 is oriented toward the hitch ball 5. The curved portion 9 is thus able to hold a trailer coupler in place once the trailer coupler is engaged to the hitch ball 5. The present invention further comprises a lock pin 16 that is utilized to secure the hold-down 7 in place within the sheath 10. The lock pin 16 laterally traverses through the sheath 10 and the linear portion 8, holding the linear portion 8 in place within the sheath 10.

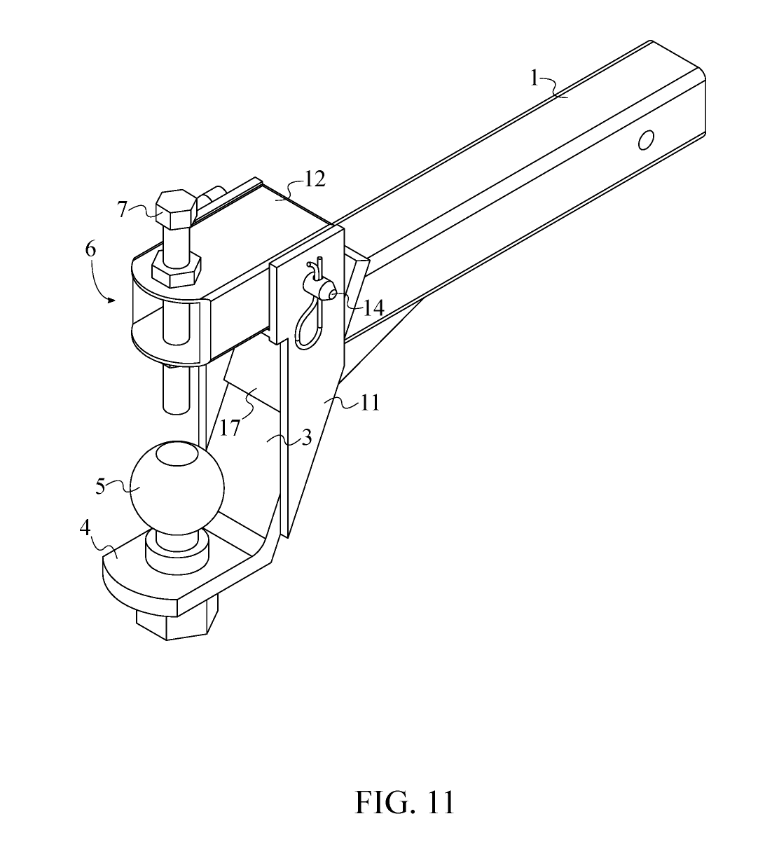

In the embodiment of the present invention shown in FIGS. 11-14, the retainer assembly 6 further comprises a mounting bracket 11 and a slipper arm 12. The mounting bracket 11 is utilized to secure the slipper arm 12 to the connector arm 3, while the slipper arm 12 is utilized to position the hold-down 7 above the hitch ball 5. The connector arm 3 is oriented at an obtuse angle 15 to the elongated mounting arm 1, positioning the ball platform 4 and the hitch ball 5 away from the elongated mounting arm 1. The mounting bracket 11 is mounted to the connector arm 3, in between the elongated mounting arm 1 and the hitch ball 5, allowing the retainer assembly 6 to be positioned in between the elongated mounting arm 1 and the hitch ball 5. The slipper arm 12 is terminally mounted within the mounting bracket 11, opposite to the connector arm 3. The slipper arm 12 is thus offset from the ball platform 4 and the hitch ball 5, allowing a trailer coupler to be engaged to the hitch ball 5 before being secured in place. The hold-down 7 is mounted for longitudinal movement into the slipper arm 12, enabling the hold-down 7 to be moved toward and away from the hitch ball 5 as needed.

With continued reference to the embodiment of the present invention in FIGS. 11-14, the present invention further comprises a stabilizing plate 17. The stabilizing plate 17 is utilized to secure the mounting bracket 11 to the connector arm 3 and prevent unwanted movement. The stabilizing plate 17 is connected within the mounting bracket 11, providing a surface that may be placed into contact with the connector arm 3. The stabilizing plate 17 is oriented parallel to the connector arm 3, ensuring that the stabilizing plate 17 may be pressed against the connector arm 3 and secured in place when the mounting bracket 11 is connected to the connector arm 3. The present invention further comprises a clevis pin 14 that is utilized to secure the slipper arm 12 to the mounting bracket 11. The clevis pin 14 traverses through the mounting bracket 11 and the slipper arm 12, fastening the slipper arm 12 in place on the mounting bracket 11.

In the embodiment of the present invention shown in FIGS. 1-4, the retainer assembly 6 further comprises a base mount 13, a mounting bracket 11, and a slipper arm 12. The base mount 13 serves to secure the mounting bracket 11 to the ball platform 4 while the mounting bracket 11 is utilized to hold the slipper arm 12. The connector arm 3 is oriented at an obtuse angle 15 to the elongated mounting arm 1, positioning the ball platform 4 and the hitch ball 5 away from the elongated mounting arm 1. The base mount 13 is mounted to the ball platform 4 and serves as a mounting point for the mounting bracket 11. The hitch ball 5 is removably mounted to the base mount 13 through the ball platform 4, securing the hitch ball 5 in place within the ball platform 4 while allowing the hitch ball 5 to be removed if needed. The mounting bracket 11 is removably mounted to the base mount 13, allowing the mounting bracket 11 to be separated from the base mount 13 as needed. The slipper arm 12 is terminally mounted within the mounting bracket 11, opposite to the base mount 13. The slipper arm 12 is thus offset from the hitch ball 5. The hold-down 7 is mounted for longitudinal movement into the slipper arm 12, allowing the hold-down 7 to be moved toward and away from the hitch ball 5 as needed.

With continued reference to the embodiment of the present invention in FIGS. 1-4, the present invention further comprises a stabilizing plate 17. The stabilizing plate 17 secures the mounting bracket 11 to the ball platform 4 and prevents unwanted movement between the mounting bracket 11 and the connector arm 3. The stabilizing plate 17 is connected within the mounting bracket 11, providing a surface that may be placed into contact with the connector arm 3. The stabilizing plate 17 is oriented parallel to the connector arm 3, allowing the stabilizing plate 17 to be pressed against the connector arm 3 and secured in place when the mounting bracket 11 is connected to the connector arm 3. The present invention further comprises a clevis pin 14 that secures the slipper arm 12 to the mounting bracket 11. The clevis pin 14 traverses through the mounting bracket 11 and the slipper arm 12, fastening the slipper arm 12 in place on the mounting bracket 11.

Although the present invention has been explained in relation to its preferred embodiment, it is understood that many other possible modifications and variations can be made without departing from the spirit and scope of the present invention as hereinafter claimed.

What is claimed is:

1. A trailer hitch with hold-down retainer comprises:
an elongated mounting arm;
a connector arm;
a ball platform;
a hitch ball;
a retainer assembly;
the retainer assembly comprises a hold-down;
the connector arm being terminally connected to the elongated mounting arm;
the ball platform being terminally connected to the connector arm, opposite to the elongated mounting arm;
the ball platform being oriented parallel to the elongated mounting arm;
the hitch ball being mounted to the ball platform;
the retainer assembly being mounted in between the elongated mounting arm and the hitch ball; and
the hold-down being offset from the hitch ball by a specified distance.

2. The trailer hitch with hold-down retainer as claimed in claim 1 further comprises:
the hitch ball being removably mounted to the ball platform.

3. The trailer hitch with hold-down retainer as claimed in claim 1 further comprises:
the connector arm being removably connected to the elongated mounting arm.

4. The trailer hitch with hold-down retainer as claimed in claim 3 further comprises:
a clevis pin;
the elongated mounting arm comprises a perpendicular sleeve;
the connector arm being mounted into the perpendicular sleeve; and
the clevis pin laterally traversing through the perpendicular sleeve and the connector arm.

5. The trailer hitch with hold-down retainer as claimed in claim 1 further comprises:
the hold-down comprises a linear portion and a curved portion;
the retainer assembly further comprises a sheath;
the connector arm being oriented at an obtuse angle to the elongated mounting arm;
the sheath being positioned on the connector arm;
the sheath being oriented perpendicular to the elongated mounting arm;
the linear portion being removably engaged into the sheath; and
the curved portion being oriented toward the hitch ball.

6. The trailer hitch with hold-down retainer as claimed in claim 5 further comprises:
a lock pin; and
the lock pin laterally traversing through the sheath and the linear portion.

7. The trailer hitch with hold-down retainer as claimed in claim 1 further comprises:
the retainer assembly further comprises a mounting bracket and a slipper arm;
the connector arm being oriented at an obtuse angle to the elongated mounting arm;
the mounting bracket being mounted to the connector arm, in between the elongated mounting arm and the hitch ball;
the slipper arm being terminally mounted within the mounting bracket, opposite to the connector arm; and
the hold-down being mounted for longitudinal movement into the slipper arm.

8. The trailer hitch with hold-down retainer as claimed in claim 7 further comprises:
a stabilizing plate;
the stabilizing plate being connected within the mounting bracket; and
the stabilizing plate being oriented parallel to the connector arm.

9. The trailer hitch with hold-down retainer as claimed in claim 7 further comprises:
a clevis pin; and
the clevis pin traversing through the mounting bracket and the slipper arm.

10. The trailer hitch with hold-down retainer as claimed in claim 1 further comprises:
the retainer assembly further comprises a base mount, a mounting bracket, and a slipper arm;
the connector arm being oriented at an obtuse angle to the elongated mounting arm;
the base mount being mounted to the ball platform;
the hitch ball being removably mounted to the base mount through the ball platform;
the mounting bracket being removably mounted to the base mount;
the slipper arm being terminally mounted within the mounting bracket, opposite to the base mount; and
the hold-down being mounted for longitudinal movement into the slipper arm.

11. The trailer hitch with hold-down retainer as claimed in claim 10 further comprises:
a stabilizing plate;
the stabilizing plate being connected within the mounting bracket; and
the stabilizing plate being oriented parallel to the connector arm.

12. The trailer hitch with hold-down retainer as claimed in claim 10 further comprises:
a clevis pin; and
the clevis pin traversing through the mounting bracket and the slipper arm.
